(19) United States
(12) Patent Application Publication
(10) Pub. No.: US 2023/0246312 A1
(43) Pub. Date: Aug. 3, 2023

(54) SECONDARY BATTERY

(71) Applicants: PRIMEARTH EV ENERGY CO., LTD., Shizuoka-ken (JP); TOYOTA JIDOSHA KABUSHIKI KAISHA, Aichi-ken (JP); Prime Planet Energy & Solutions, Inc., Tokyo (JP)

(72) Inventors: Shigeru MATSUMOTO, Toyohashi-shi (JP); Yozo UCHIDA, Toyota-shi (JP); Yuki SATO, Toyota-shi (JP); Tsuyoshi EHARA, Toyota-shi (JP)

(21) Appl. No.: 18/069,935

(22) Filed: Dec. 21, 2022

(30) Foreign Application Priority Data
Jan. 28, 2022 (JP) 2022-011937

(51) Int. Cl. H01M 50/557; H01M 50/15; H01M 50/186; H01M 50/505

(52) U.S. Cl. CPC H01M 50/557; H01M 50/15; H01M 50/186; H01M 50/505

(57) ABSTRACT

In a secondary battery, a lid member and a negative terminal are integrated through a resin. The negative terminal includes a first member and a second member. A first bonded surface of a lower surface of the first member is bonded to a second bonded surface of an upper surface of the second member. The first member includes a projecting portion at an outer peripheral edge of the lower surface of the first member. The second member includes a chamfered portion at an outer peripheral edge of the upper surface of the second member. The projecting portion and the chamfered portion are combined with each other so that the projecting portion contacts the chamfered portion.

### CROSS-REFERENCE TO RELATED APPLICATIONS

This application is based upon and claims the benefit of priority to Japanese Patent Application No. 2022-011937 filed on Jan. 28, 2022, the entire contents of which are incorporated herein by reference.

### BACKGROUND

### Technical Field

The present disclosure relates to a secondary battery.

### Related Art

As one of conventional arts related to a secondary battery, Japanese unexamined patent application publication No. 2021-086813 (JP2021-086813A) discloses a battery (a sealed battery) in which electrode terminals (i.e., current collecting terminals) are placed in through holes of a lid member (i.e., a lid body), and the lid member and the electrode terminals are integrated with resin (i.e., an insulating member).

### SUMMARY

### Technical Problems

Such an electrode terminal as disclosed in JP2021-086813A may be composed of a first member and a second member, which are made of different materials and bonded to each other. In this case, when the lid member and the electrode terminal is to be integrally connected with resin, this resin may penetrate between the first member and the second member, causing deformation of the first member. This may make it impossible to weld a busbar to the first member and may cause damages to a bonded zone between the first member and the second member.

The present disclosure has been made to address the above problems and has a purpose to provide a secondary battery including an electrode terminal composed of a first member and a second member bonded to each other, the electrode terminal being integrated with a lid member with a resin by preventing the resin from entering, or penetrating, between the first and second members when the resin flows in between the electrode terminal and the lid member.

### Means of Solving the Problems

To achieve the above-mentioned purpose, one aspect of the present disclosure provides a secondary battery comprising: a case having an opening; a lid member that closes the opening; and an electrode terminal, wherein the lid member and the electrode terminal are integrated with resin, the electrode terminal includes a first member and a second member placed under the first member, the first member includes a lower surface including: an outer peripheral edge; and a first bonded surface located inside the outer peripheral edge, the second member includes an upper surface including: an outer peripheral edge; and a second bonded surface located inside the outer peripheral edge, at least a part of the first bonded surface and at least a part of the second bonded surface are bonded to each other, the first member further includes a projecting portion along the outer peripheral edge of the lower surface, the projecting portion projecting downward from the first bonded surface, the second member further includes a chamfered portion along the outer peripheral edge of the upper surface, the chamfered portion inclining outward and downward from the second bonded surface, and the projecting portion of the first member and the chamfered portion of the second member combined with each other so that the projecting portion contacts at least a part of the chamfered portion.

According to the above aspect, the projecting portion and the chamfered portion are combined with each other, which can block the molten resin from penetrating, or entering, between the first and second members in the course of flowing the resin between the lid member and the electrode terminal in order to integrate those lid member and electrode terminal with each other through the resin. Further, the first member with the projecting portion can have an increased cross-sectional area by just that much, increasing the second moment of area, and resulting in improved rigidity. This configuration can therefore prevent deformation of the first member and damages to the bonded zone where the first member and the second member are bonded to each other.

The secondary battery of the present disclosure can be provided with an electrode terminal composed of a first member and a second member bonded to each other and integrated with a lid member with a resin by preventing the resin from penetrating between the first and second members when the resin flows in between the electrode terminal and the lid member.

### BRIEF DESCRIPTION OF THE DRAWINGS

FIG. 1 is a perspective view of an entire secondary battery in an embodiment;

FIG. 2 is a perspective view of an assembly in which a lid member and each electrode terminal (i.e., a negative terminal and a positive terminal) are integrated with a resin;

FIG. 3 is a perspective view of the negative terminal;

FIG. 4 is a cross-sectional view (i.e., a cross-section A-A in FIG. 3);

FIG. 5 is a cross-sectional view of a first member and a second member of the negative terminal;

FIG. 6 is a perspective view of the first member and the second member of the negative terminal;

FIG. 7 is a diagram showing a modified example in which a distal end of the projecting portion is rounded;

FIG. 8 is a diagram showing another modified example in which a projecting portion and a chamfered portion are located in only a long side of respective rectangular outer peripheral edge; and

FIG. 9 is a cross-sectional view of a negative terminal in a related art.

### DETAILED DESCRIPTION OF THE EXEMPLARY EMBODIMENTS

A detailed description of an embodiment of a secondary battery of the present disclosure will now be given referring to the accompanying drawings.

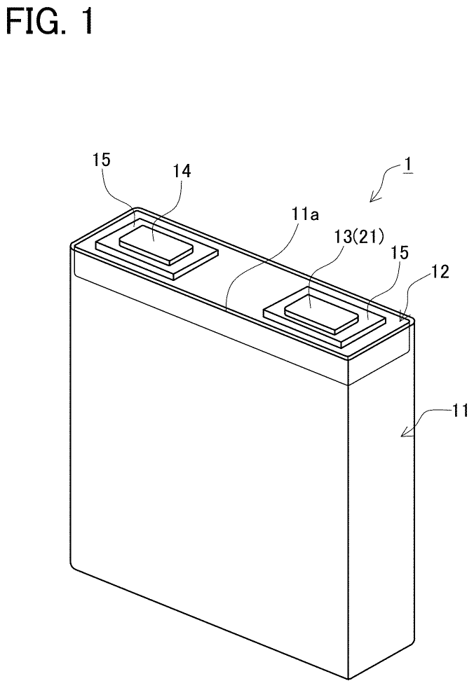

As shown in FIG. 1, a secondary battery 1 in the present embodiment includes a case 11 having an opening 11a, and a lid member 12 having a rectangular plate-like shape and closing the opening 11a. The case 11 and the lid member 12 are each made of metal, for example, aluminum.

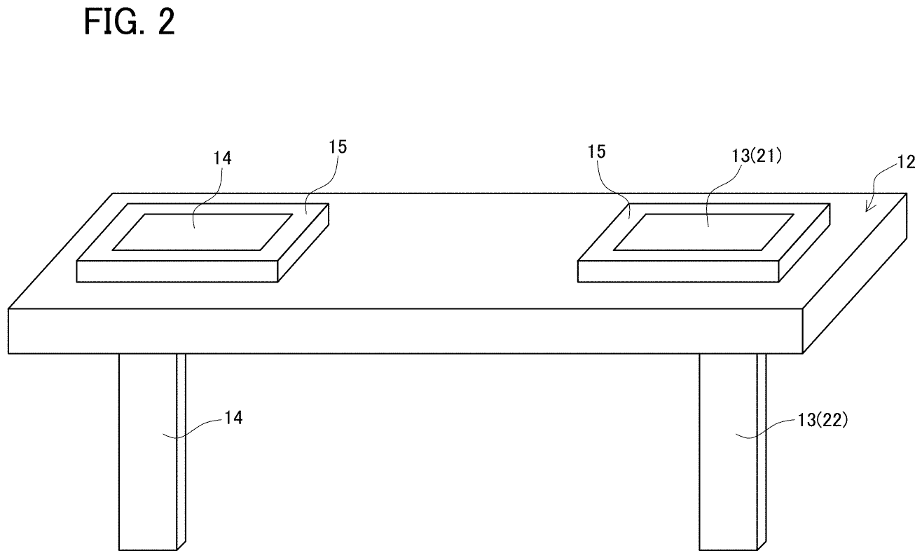

As shown in FIGS. 1 and 2, the lid member 12 and electrode terminals, i.e., a negative terminal 13 and a positive terminal 14, are integrated with each other with a resin 15. Thus, the lid member 12 and the negative terminal 13 are insulated from each other by the resin 15 and similarly the lid member 12 and the positive terminal 14 are insulated from each other by the resin 15. The negative terminal 13 and the positive terminal 14 are placed in through holes (not shown) of the lid member 12. Further, the negative terminal 13 and the positive terminal 14 are each connected to an electrode body (not shown) accommodated in the case 11.

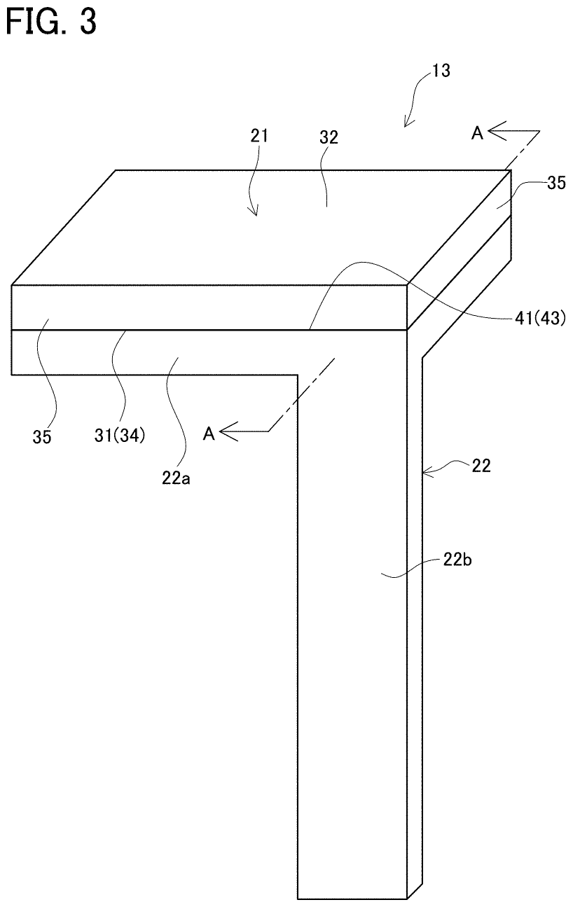

In the present embodiment, as shown in FIG. 3, the negative terminal 13 includes a first member 21 and a second member 22 located under the first member 21. The first member 21 and the second member 22 are made of different materials; for example, the first member 21 is made of aluminum and the second member 22 is made of copper. The first member 21 is located on the upper side and the second member 22 is located on the lower side with respect to the lid member 12. These first member 21 and the second member 22 are bonded to each other through the through hole (not shown) formed in the lid member 12.

The first member 21 has a rectangular plate-like shape, having a lower surface 31 and an upper surface 32 which are rectangular. The lower surface 31 of the first member 21 is bonded to an upper surface 41 of the second member 22. The upper surface 32 of the first member 21 is connectable to a busbar (not shown) connected to an external power source (not shown). The busbar is made of aluminum, for example.

The second member 22 includes a bonded part 22a bonded to the first member 21 and a columnar part 22b extending downward from this bonded part 22a, as shown in FIG. 3. The bonded part 22a has a rectangular plate-like shape with the rectangular upper surface 41. The columnar part 22b has a rectangular column shape and is connected to the electrode body accommodated in the case 11. The columnar part 22b is not limited to the rectangular column shape, but may also be of a bent plate shape or a three-dimensionally bent or curved stereoscopic shape.

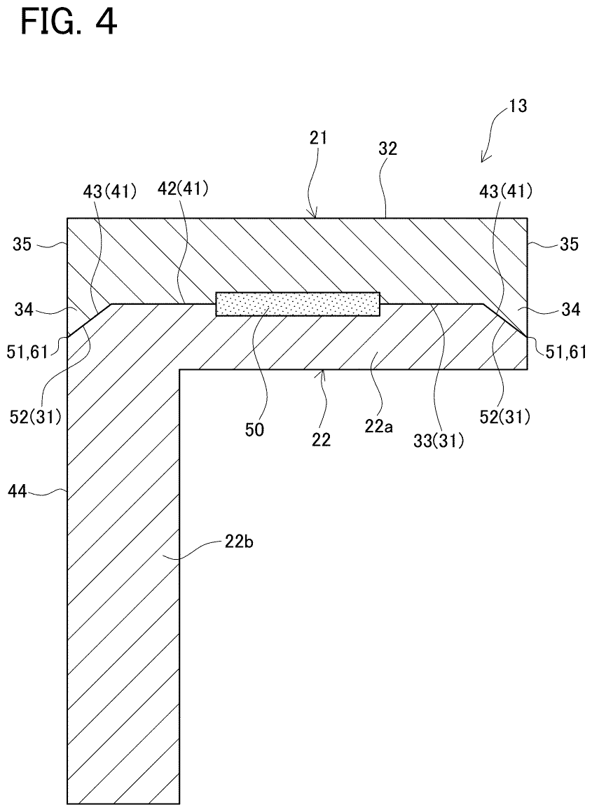

The lower surface 31 of the first member 21 includes a first bonded surface 33 located inside the outer peripheral edge (right and left ends in FIG. 4) and the upper surface 41 of the second member 22 includes a second bonded surface 42 located inside the outer peripheral edge (right and left ends in FIG. 4). As shown in FIG. 4, a part of the first bonded surface 33 (specifically, a central part of the first bonded surface 33) and a part of the second bonded surface 42 (specifically, a central part of the second bonded surface 42) are bonded to each other by ultrasonic bonding, that is, bonding between different materials. FIG. 4 exemplifies that a part of the first bonded surface 33 and a part of the second bonded surface 42 are bonded to each other. However, the present disclosure is not limited to this example, and the entire area of the first bonded surface 33 and the entire area of the second bonded surface 42 may be bonded to each other.

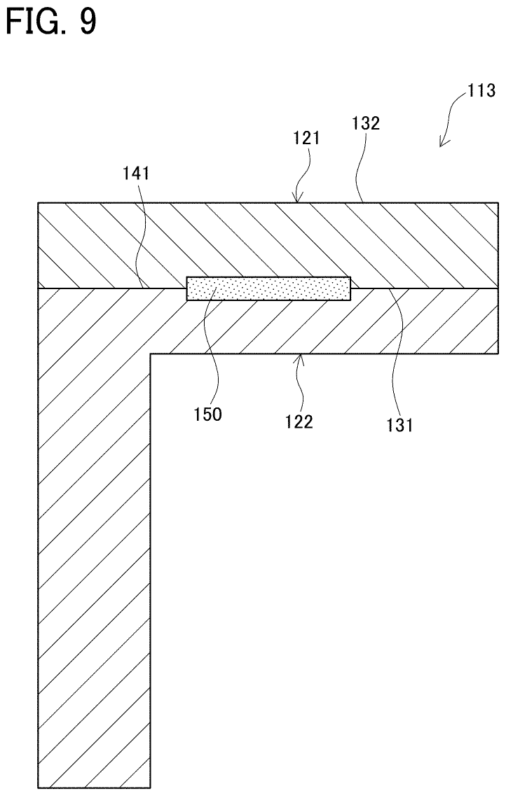

Herein, consideration is given to the process of flowing the resin 15 in a molten state between the lid member 12 and the negative terminal 13 in order to integrate the lid member 12 and the negative terminal 13 with each other with the resin 15. When a conventional negative terminal 113 as shown in FIG. 9 is used in this case, a lower surface 131 of a first member 121 and an upper surface 141 of a second member 122 are each flat over the entire area, which may cause penetration of a resin from outside of the negative terminal 113 to between the lower surface 131 of the first member 121 and the upper surface 141 of the second member 122.

Further, such penetration of resin may cause deformation of the first member 121, disabling welding of a busbar to the upper surface 132 of the first member 121, and also cause damages to a bonded zone 150 where the lower surface 131 of the first member 121 and the upper surface 141 of the second member 122 are bonded to each other. In addition, when a busbar is welded to the upper surface 132 of the first member 121, the first member 121 may be deformed, causing damages to the bonded zone 150 where the lower surface 131 of the first member 121 and the upper surface 141 of the second member 122 are bonded to each other.

In contrast, in the present embodiment, as shown in FIGS. 4 to 6, the first member 21 includes a projecting portion 34 along the outer peripheral edge of the lower surface 31 of the first member 21. This projecting portion 34 projects downward from the first bonded surface 33.

The second member 22 includes a chamfered portion 43 along the outer peripheral edge of the upper surface 41 of the second member 22. This chamfered portion 43 is inclined outward (rightward and leftward in FIG. 4) and downward from the second bonded surface 42.

The projecting portion 34 is combined with the chamfered portion 43 so that the projecting portion 34 contacts, or engages, the chamfered portion 43 as shown in FIG. 4.

The projecting portion 34 and the chamfered portion 43 are combined in engagement with each other as above. This combined structure of the projecting portion 34 and the chamfered portion 43 can block the molten resin 15 from penetrating between the first member 21 and the second member 22 when the resin 15 flows in between the lid member 12 and the negative terminal 13 in order to integrate these lid member 12 and negative terminal 13 with each other through the resin 15. Furthermore, the first member 21 with the projecting portion 34 can have an increased cross-sectional area by just that much, increasing the second moment of area, and resulting in improved rigidity.

Therefore, the above structure can prevent the resin from easily entering between the first member 21 and the second member 22, which may cause deformation of the first member 21 and damages to a bonded zone 50 where the first member 21 and the second member 22 are bonded to each other. Moreover, in welding a busbar to the upper surface 32 of the first member 21, it is possible to prevent deformation of the first member 21 and also damages to the bonded zone 50 of the first member 21 and the second member 22.

FIG. 4 exemplifies that the projecting portion 34 is in contact with the entire area of the chamfered portion 43. However, the present disclosure is not limited to this example, and the projecting portion 34 may be in contact with only a part of the chamfered portion 43.

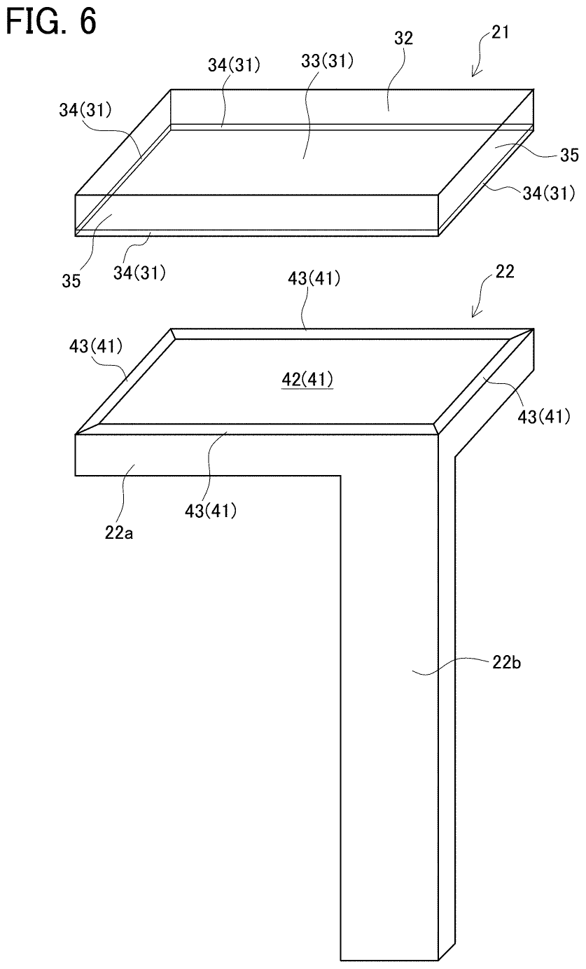

Furthermore, as shown in FIG. 6, the outer peripheral edge of the lower surface 31 of the first member 21 and the outer peripheral edge of the upper surface 41 of the second member 22 each have a rectangular shape having four sides, i.e., two short sides and two long sides. The projecting portion 34 extends over the entire circumference, i.e., along all the four sides, of the outer peripheral edge of the lower surface 31 of the first member 21 in the circumferential direction. The chamfered portion 43 also extends over the entire circumference, i.e., along all the four sides, of the outer peripheral edge of the upper surface 41 of the second member 22 in the circumferential direction.

The lower surface 31 of the first member 21 and the upper surface 41 of the second member 22 are respectively formed with the projecting portion 34 and the chamfered portion 43, which are respectively formed all around the lower surface 31 and the upper surface 42 as described above. This configuration can therefore more effectively prevent the resin from entering between the first member 21 and the second member 22 of the negative terminal 13 when the resin 15 runs in between the lid member 12 and the negative terminal 13.

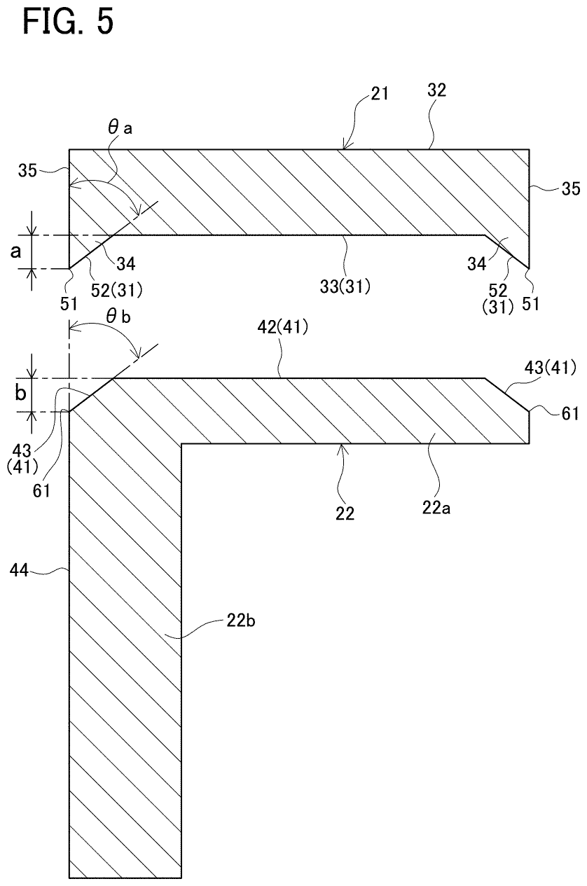

In the present embodiment, a projection height a of the projecting portion 34 (see FIG. 5) is set equal to or larger than a chamfer depth b of the chamfered portion 43 (see FIG. 5). Herein, as shown in FIG. 5, the projection height a of the projecting portion 34 is a distance in a vertical direction from the first bonded surface 33 to a distal end 51 of the projecting portion 34. The chamfer depth b of the chamfered portion 43 is a distance in the vertical direction from the second bonded surface 42 to a lower end 61 of the chamfered portion 43. FIGS. 4 and 5 show one example where the projection height a is equal to the chamfer depth b. However, in the present embodiment in which the projection height a is equal to or larger than the chamfer depth b, the projection height a may be set larger than the chamfer depth b.

Since the projection height a is equal to or larger than the chamfer depth b as described above, even if a gap occurs between the first bonded surface 33 and the second bonded surface 42 when the first member 21 is bonded to the second member 22, no gap is generated between contact portions (outer peripheral portions) of the projecting portion 34 and the chamfered portion 43 in contact with each other. This configuration can therefore more effectively prevent the resin 15 from penetrating between the first member 21 and the second member 22 when the resin 15 flows in between the lid member 12 and the negative terminal 13 to integrally connect the lid member 12 and the negative terminal 13 with the resin 15.

Herein, as one example of concrete conditions for the relationship between the projection height a and the chamfer depth b, the following expressions 1 and 2 should be satisfied:

(a−b)<0.1 [mm] (Exp. 1), and

0.1 [mm]<a<0.5t (Exp. 2)

wherein t denotes the thickness of the first member 21, concretely, at the position of the first bonded surface 33.

The inclination angle θa of the projecting portion 34 (see FIG. 5) is preferably equal to or smaller than the inclination angle θb of the chamfered portion 43 (see FIG. 5). Herein, as shown in FIG. 5, the inclination angle θa is the angle at which a projecting inclined face 52 of the projecting portion 34 is inclined with respect to an outer peripheral surface 35 of the first member 21. The inclination angle θb is the angle at which the chamfered portion 43 is inclined with respect to the outer peripheral surface 35 of the first member 21, i.e., an outer peripheral surface 44 of the second member 22. The projecting inclined face 52 is a part of the projecting portion 34, which is inclined with respect to the outer peripheral surface 35 of the first member 21 to face the chamfered portion 43.

The inclination angle θa of the projecting portion 34 is set equal to or smaller than the inclination angle θb of the chamfered portion 43 as described above, so that the projecting portion 34 and the chamfered portion 43 are combined in engagement with reduced interference amount (i.e., the contact amount) therebetween. Therefore, the first member 21 and the second member 22 are bonded to each other without being affected by the interference between the projecting portion 34 and the chamfered portion 43 by which the first member 21 and the second member 22 are hard to bond to each other.

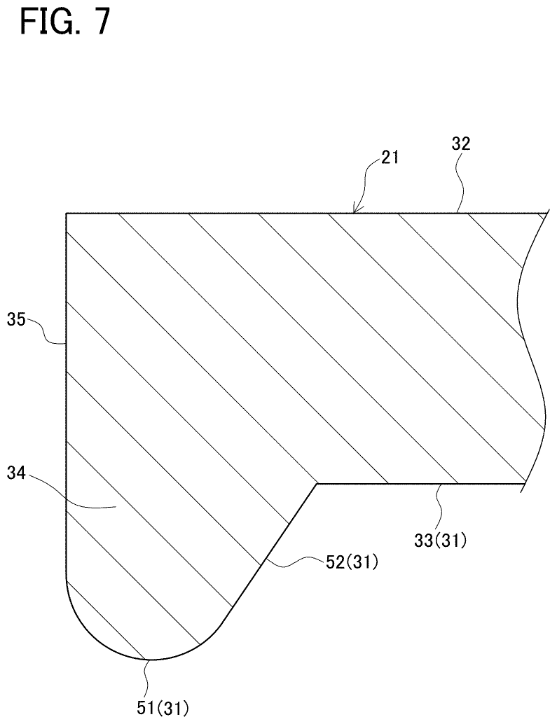

As a modified example, as shown in FIG. 7, the distal end 51 of the projecting portion 34 may be formed in a rounded or circular shape in cross-section. Accordingly, the first member 21 and the second member 22 can be bonded to each other without being affected by the interference between the distal end 51 of the projecting portion 34 and the chamfered portion 43 by which the first member 21 and the second member 22 are hard to bond to each other.

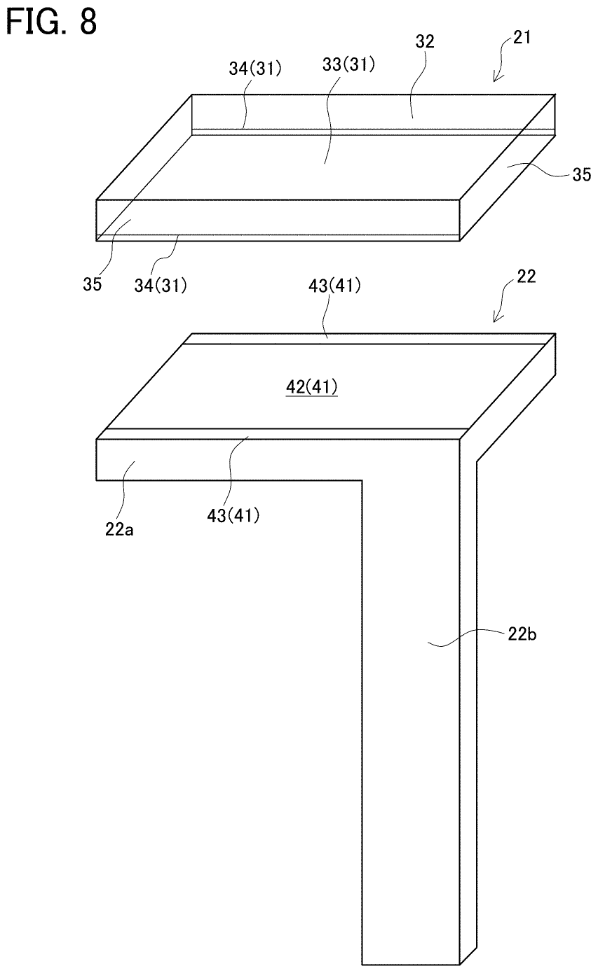

As another modified example, as shown in FIG. 8, the first member 21 may be formed with the projecting portion 34 only at the positions corresponding to two long sides of the rectangular outer peripheral edge of the lower surface 31 of the first member 21 in the circumferential direction thereof. Accordingly, the second member 22 may be formed with the chamfered portion 43 only at the positions corresponding to two long sides of the rectangular outer peripheral edge of the upper surface 41 of the second member 22 in the circumferential direction thereof.

Accordingly, even though the projecting portion 34 and the chamfered portion 43 are each formed in as small a size as possible, it is possible to prevent the resin 15 from penetrating between the first member 21 and the second member 22 when the resin 15 flows in between the lid member 12 and the negative terminal 13.

The foregoing embodiments are mere examples and give no limitation to the present disclosure. The present disclosure may be embodied in other specific forms without departing from the essential characteristics thereof.

The above description describes for example that the outer peripheral edge of the lower surface 31 of the first member 21 and the outer peripheral edge of the upper surface 41 of the second member 22 each have a rectangular shape. In the present disclosure, this term “rectangular shape” also includes a rectangular shape with some or all of four corners rounded or chamfered.

For a busbar made of copper, the foregoing structure of the negative terminal 13 may also be adopted as the structure of the positive terminal 14. In this case, the first member 21 is made of copper and the second member 22 is made of aluminum.

In the above description, the terms “upper side”, “upper surface”, “lower side”, “lower surface”, etc. are merely assigned for convenience and do not limit the orientation of the secondary battery 1 in the vertical direction. In other words, the orientation of the secondary battery 1 in the vertical direction can be changed.

In the above configuration, a projection height of the projecting portion of the first member, the projection height being a distance from the first bonded surface to a distal end of the projecting portion in a vertical direction, may be equal to or larger than a chamfer depth of the chamfered portion of the second member, the chamfer depth being a distance from the second bonded surface to a lower end of the chamfered portion.

The above configuration can more effectively prevent the resin from penetrating between the first member and the second member.

In the above aspect, the projecting portion of the first member may include a projecting inclined face that is inclined with respect to an outer peripheral surface of the first member and faces the chamfered portion, and an inclination angle of the projecting inclined face with respect to the outer peripheral surface of the first member may be equal to or smaller than an inclination angle of the chamfered portion with respect to the outer peripheral surface of the first member

Thus, the first member and the second member are bonded to each other without being affected by the interference between the projecting portion and the chamfered portion.

In the above aspect, the distal end of the projecting portion may have a rounded shape in cross-section.

Thus, the first member and the second member are bonded to each other without being affected by the interference between the distal end of the projecting portion and the chamfered portion.

In the above aspect, the projecting portion may extend over the entire circumference of the outer peripheral edge of the lower surface of the first member in a circumference direction, and the chamfered portion may extend over the entire circumference of the outer peripheral edge of the upper surface of the second member in a circumference direction.

The above configuration can more effectively prevent the resin from penetrating between the first member and the second member.

In the above aspect, it may be configured such that the outer peripheral edge of the lower surface of the first member has a rectangular shape, the projecting portion is located in a long side of the rectangular outer peripheral edge of the lower surface of the first member in the circumference direction, the outer peripheral edge of the upper surface of the second member has a rectangular shape, and the chamfered portion is located in a long side of the rectangular outer peripheral edge of the upper surface of the second member in the circumference direction. It is to be noted that the “rectangular shape” in the above configuration also includes a rectangular shape with some or all of four corners rounded or chamfered.

The above configuration can prevent the resin from penetrating between the first member and the second member, even though the projecting portion and the chamfered portion are each formed in as small a size as possible.

In the above aspect, it may be configured such that the first member is connectable to a busbar connected to an external power source, the second member is connected to an electrode body accommodated in the case, and the first member and the second member are made of different materials.

### REFERENCE SIGNS LIST

1 Secondary battery
11 Case
11a Opening
12 Lid member
13 Negative terminal
14 Positive terminal
15 Resin
21 First member
22 Second member
22a Bonded part
22b Columnar part
31 Lower surface
32 Upper surface
33 First bonded surface
34 Projecting portion
35 Outer peripheral surface
41 Upper surface
42 Second bonded surface
43 Chamfered portion
44 Outer peripheral surface
51 Distal end
52 Projecting inclined face
61 Lower end
a Projection height
b Chamfer depth
θa Inclination angle
θb Inclination angle

What is claimed is:

1. A secondary battery comprising:
a case having an opening;
a lid member that closes the opening; and
an electrode terminal,
wherein the lid member and the electrode terminal are integrated with resin,
the electrode terminal includes a first member and a second member placed under the first member,
the first member includes a lower surface including: an outer peripheral edge; and a first bonded surface located inside the outer peripheral edge,
the second member includes an upper surface including: an outer peripheral edge; and a second bonded surface located inside the outer peripheral edge,
at least a part of the first bonded surface and at least a part of the second bonded surface are bonded to each other,
the first member further includes a projecting portion along the outer peripheral edge of the lower surface, the projecting portion projecting downward from the first bonded surface,
the second member further includes a chamfered portion along the outer peripheral edge of the upper surface, the chamfered portion inclining outward and downward from the second bonded surface, and
the projecting portion of the first member and the chamfered portion of the second member combined with each other so that the projecting portion contacts at least a part of the chamfered portion.

2. The secondary battery according to claim 1, wherein a projection height of the projecting portion of the first member, the projection height being a distance from the first bonded surface to a distal end of the projecting portion in a vertical direction, is equal to or larger than a chamfer depth of the chamfered portion of the second member, the chamfer depth being a distance from the second bonded surface to a lower end of the chamfered portion.

3. The secondary battery according to claim 1, wherein
the projecting portion of the first member includes a projecting inclined face that is inclined with respect to an outer peripheral surface of the first member and faces the chamfered portion, and
an inclination angle of the projecting inclined face with respect to the outer peripheral surface of the first member is equal to or smaller than an inclination angle of the chamfered portion with respect to the outer peripheral surface of the first member.

4. The secondary battery according to claim 2, wherein
the projecting portion of the first member includes a projecting inclined face that is inclined with respect to an outer peripheral surface of the first member and faces the chamfered portion, and
an inclination angle of the projecting inclined face with respect to the outer peripheral surface of the first member is equal to or smaller than an inclination angle of the chamfered portion with respect to the outer peripheral surface of the first member.

5. The secondary battery according to claim 1, wherein the distal end of the projecting portion has a rounded shape in cross-section.

6. The secondary battery according to claim 2, wherein the distal end of the projecting portion has a rounded shape in cross-section.

7. The secondary battery according to claim 3, wherein the distal end of the projecting portion has a rounded shape in cross-section.

8. The secondary battery according to claim 4, wherein the distal end of the projecting portion has a rounded shape in cross-section.

9. The secondary battery according to claim 1, wherein
the projecting portion extends over the entire circumference of the outer peripheral edge of the lower surface of the first member in a circumference direction, and
the chamfered portion extends over the entire circumference of the outer peripheral edge of the upper surface of the second member in a circumference direction.

10. The secondary battery according to claim 2, wherein
the projecting portion extends over the entire circumference of the outer peripheral edge of the lower surface of the first member in a circumference direction, and
the chamfered portion extends over the entire circumference of the outer peripheral edge of the upper surface of the second member in a circumference direction.

11. The secondary battery according to claim 3, wherein
the projecting portion extends over the entire circumference of the outer peripheral edge of the lower surface of the first member in a circumference direction, and
the chamfered portion extends over the entire circumference of the outer peripheral edge of the upper surface of the second member in a circumference direction.

12. The secondary battery according to claim 4, wherein
the projecting portion extends over the entire circumference of the outer peripheral edge of the lower surface of the first member in a circumference direction, and
the chamfered portion extends over the entire circumference of the outer peripheral edge of the upper surface of the second member in a circumference direction.

13. The secondary battery according to claim 5, wherein
the projecting portion extends over the entire circumference of the outer peripheral edge of the lower surface of the first member in a circumference direction, and
the chamfered portion extends over the entire circumference of the outer peripheral edge of the upper surface of the second member in a circumference direction.

14. The secondary battery according to claim 6, wherein
the projecting portion extends over the entire circumference of the outer peripheral edge of the lower surface of the first member in a circumference direction, and
the chamfered portion extends over the entire circumference of the outer peripheral edge of the upper surface of the second member in a circumference direction.

15. The secondary battery according to claim 7, wherein
the projecting portion extends over the entire circumference of the outer peripheral edge of the lower surface of the first member in a circumference direction, and
the chamfered portion extends over the entire circumference of the outer peripheral edge of the upper surface of the second member in a circumference direction.

16. The secondary battery according to claim 8, wherein
the projecting portion extends over the entire circumference of the outer peripheral edge of the lower surface of the first member in a circumference direction, and
the chamfered portion extends over the entire circumference of the outer peripheral edge of the upper surface of the second member in a circumference direction.

17. The secondary battery according to claim 1, wherein
the outer peripheral edge of the lower surface of the first member has a rectangular shape,
the projecting portion is located in a long side of the rectangular outer peripheral edge of the lower surface of the first member in the circumference direction,
the outer peripheral edge of the upper surface of the second member has a rectangular shape, and
the chamfered portion is located in a long side of the rectangular outer peripheral edge of the upper surface of the second member in the circumference direction.

18. The secondary battery according to claim 2, wherein
the outer peripheral edge of the lower surface of the first member has a rectangular shape,
the projecting portion is located in a long side of the rectangular outer peripheral edge of the lower surface of the first member in the circumference direction, the outer peripheral edge of the upper surface of the second member has a rectangular shape, and
the chamfered portion is located in a long side of the rectangular outer peripheral edge of the upper surface of the second member in the circumference direction.

19. The secondary battery according to claim 3, wherein
the outer peripheral edge of the lower surface of the first member has a rectangular shape,
the projecting portion is located in a long side of the rectangular outer peripheral edge of the lower surface of the first member in the circumference direction,
the outer peripheral edge of the upper surface of the second member has a rectangular shape, and
the chamfered portion is located in a long side of the rectangular outer peripheral edge of the upper surface of the second member in the circumference direction.

20. The secondary battery according to claim 1, wherein
the first member is connectable to a busbar connected to an external power source,
the second member is connected to an electrode body accommodated in the case, and
the first member and the second member are made of different materials.
